(19) United States
(12) Patent Application Publication
(10) Pub. No.: US 2009/0237788 A1
(43) Pub. Date: Sep. 24, 2009

(54) OPTICAL APPARATUS AND PROJECTOR

(75) Inventor: Takashi Endo, Azumino-shi (JP)

Correspondence Address: ADVANTEDGE LAW GROUP, LLC, 922 W. BAXTER DRIVE, SUITE 100, SOUTH JORDAN, UT, 84095, US

(73) Assignee: Seiko Epson Corporation, Tokyo (JP)

(21) Appl. No.: 12/405,836

(22) Filed: Mar. 17, 2009

(30) Foreign Application Priority Data
Mar. 19, 2008 (JP) 2008-071997
Jan. 19, 2009 (JP) 2009-008650

(51) Int. Cl. G02B 27/28

(52) U.S. Cl. 359/496

(57) ABSTRACT

An optical apparatus includes an optical element disposed on an optical path along which the light flux emitted from a light source travels, and a polarizing element disposed on the light flux emitting-side of the optical element. The polarizing element includes a first prism having a light flux incident-side end surface on which the light flux having emitted from the optical element is incident and an emitting-side inclined surface inclined to the light flux incident-side end surface, and a polarizing element body provided on the emitting-side inclined surface, the polarizing element body transmitting first linearly polarized light out of the light flux having passed through the first prism and reflecting second linearly polarized light polarized perpendicular to the first linearly polarized light toward the first prism. The optical element is integrated with the polarizing element with an interposed adhesive layer formed on the light flux incident-side end surface. The refractive index n0 of the adhesive layer is set to satisfy the following equation:

1≦n1/n0×sin [2φ−arcsin {n0/n1×sin(θ−φ)}−2φ]

where n1 represents the refractive index of the first prism, θ represents the angle between the optical axis of the light flux emitted from the light source and the light flux incident on the light flux incident-side end surface, φ represents the angle between a plane orthogonal to the optical axis and the light flux incident-side end surface, and φ represents the angle between the orthogonal plane and the emitting-side inclined surface.

### BACKGROUND

1. Technical Field

The present invention relates to an optical apparatus and a projector.

2. Related Art

There has been a projector including a light source apparatus, a light modulator that modulates the light flux emitted from the light source apparatus in accordance with image information to form image light, and a projection optical apparatus that enlarges and projects the image light.

In such a projector, polarizing elements are typically disposed on the light flux incident side and the light flux emitting side of the light modulator (liquid crystal panel), each of the polarizing elements transmitting a predetermined linearly polarized light out of the incident light flux and blocking the other part of the light flux (see International Publication WO 01/055778, for example).

In the projector described in International Publication WO 01/055778, a reflective polarizing element is used as the polarizing element disposed on the light flux emitting side of the liquid crystal panel (hereinafter referred to as an emitting-side polarizing element) to not only improve the light resistance and heat resistance of the emitting-side polarizing element but also prevent unwanted light flux reflected off the emitting-side polarizing element from being incident on the liquid crystal panel.

Specifically, the emitting-side polarizing element includes a triangular cross-sectional prism having a light flux incident-side end surface perpendicular to the optical axis of the incident light flux and an inclined surface inclined to the light flux incident-side end surface, and a reflective polarizing plate provided on the inclined surface of the prism. The unwanted light flux reflected off the reflective polarizing plate is totally reflected off the light flux incident-side end surface of the prism and is not directed toward the liquid crystal panel.

In consideration of the handleability in assembling the liquid crystal panel and the emitting-side polarizing element in the projector, the liquid crystal panel is preferably integrated with the emitting-side polarizing element into a single optical apparatus by bonding the liquid crystal panel to the light flux incident-side end surface of the emitting-side polarizing element with an adhesive.

Such a configuration, however, is problematic in that the light reflected off the reflective polarizing plate is not totally reflected but emits through the light flux incident-side end surface depending on the refractive index of the adhesive and the light flux having emitted therethrough affects the liquid crystal panel.

### SUMMARY

An advantage of some aspects of the invention is to provide an optical apparatus that can be readily handled and reduced in size, and a projector.

An optical apparatus according to a first aspect of the invention includes an optical element disposed on an optical path along which the light flux emitted from a light source travels, and a polarizing element disposed on the light flux emitting-side of the optical element. The polarizing element includes a first prism having a light flux incident-side end surface on which the light flux having emitted from the optical element is incident and an emitting-side inclined surface inclined to the light flux incident-side end surface, and a polarizing element body provided on the emitting-side inclined surface, the polarizing element body transmitting first linearly polarized light out of the light flux having passed through the first prism and reflecting second linearly polarized light polarized perpendicular to the first linearly polarized light toward the first prism. The optical element is integrated with the polarizing element with an interposed adhesive layer formed on the light flux incident-side end surface. The refractive index n0 of the adhesive layer is set to satisfy the following equation (1):

1≦n1/n0×sin [2φ−arcsin {n0/n1×sin(θ−φ)}−2φ] (1)

where n1 represents the refractive index of the first prism, θ represents the angle between the optical axis of the light flux emitted from the light source and the light flux incident on the light flux incident-side end surface, φ represents the angle between a plane orthogonal to the optical axis and the light flux incident-side end surface, and φ represents the angle between the orthogonal plane and the emitting-side inclined surface.

In the first aspect of the invention, X, Y and Z axes are defined as follows: The Z axis is the optical axis of the light flux emitted from the light source (Let the +Z axis direction be the direction in which the light flux is directed). The X axis is perpendicular to not only the z axis but also a normal to the light flux incident-side end surface. The Y axis is perpendicular to the X and Z axes. Further, let the +Y axis direction be the direction in which the distance in the Z-axis direction between the light flux incident-side end surface and the emitting-side inclined surface decreases as the coordinate along the +Y axis increases.

The angle θ between the optical axis of the light flux emitted from the light source and the light incident on the light flux incident-side end surface, the angle φ between a plane orthogonal to the optical axis and the light flux incident-side end surface, and the angle φ between the orthogonal plane and the emitting-side inclined surface have positive values along the direction in which the +Z-axis is rotated around the X-axis toward the +Y-axis.

According to the first aspect of the invention, integrating the optical element with the polarizing element with the interposed adhesive layer formed on the light flux incident-side end surface allows improvement in handleability and reduction in size.

Since the refractive index n0 of the adhesive layer is set to satisfy the equation (1), the second linearly polarized light reflected off the polarizing element body is totally reflected off the light flux incident-side end surface and is not directed toward the optical element. The light flux having emitted from the polarizing element will therefore not affect the optical element.

In the optical apparatus according to the first aspect of the invention, the polarizing element preferably further includes a second prism having a light flux emitting-side end surface parallel to the light flux incident-side end surface and transmitting the first linearly polarized light having passed through the polarizing element body, and an incident-side inclined surface inclined to the light flux emitting-side end surface and facing the emitting-side inclined surface, and the second prism is preferably integrated with the first prism.

According to the configuration described above, the polarizing element includes the second prism having the light flux emitting-side end surface parallel to the light flux incident-side end surface of the first prism. Since the light flux incident-side end surface is parallel to the light flux emitting-side end surface, the first linearly polarized light that emits through the light flux emitting-side end surface can be set to travel in substantially the same direction as that in which the light flux incident on the polarizing element travels. Therefore, when optical components disposed upstream of the optical element in the optical path and optical components disposed downstream of the polarizing element in the optical path are incorporated in the optical apparatus, the optical system can be readily configured. That is, optical components disposed upstream of the optical element in the optical path and optical components disposed downstream of the polarizing element in the optical path can be incorporated in the optical apparatus, whereby the handleability can be further improved.

In the optical apparatus according to the first aspect of the invention, the optical element is preferably comprised of a light modulator including a drive substrate and a counter substrate facing each other and liquid crystal molecules encapsulated between the drive substrate and the counter substrate, the light modulator modulating the incident light flux in accordance with image information to form image light.

In the configuration described above, since the optical element is comprised of the light modulator, the space between the light modulator and the emitting-side polarizing element can be sealed. No dust will therefore adhere to the light modulator or the emitting-side polarizing element. It is therefore not necessary to attach a dust protective glass on the light flux emitting side of the light modulator, the dust protective glass shifting any dust that has adhered from the focal position to prevent the dust from creating a shadow in the image light. The configuration of the optical apparatus can therefore be simplified and further reduced in size.

A projector according to a second aspect of the invention includes a light source apparatus, a light modulator that modulates the light flux emitted from the light source apparatus in accordance with image information to form image light, a projection optical apparatus that enlarges and projects the image light, and the optical apparatus described above.

In the second aspect of the invention, the projector including the optical apparatus described above can provide advantageous effects that are same as those provided in the optical apparatus described above.

### BRIEF DESCRIPTION OF THE DRAWINGS

The invention will now be described with reference to the accompanying drawings, wherein like numbers reference like elements.

FIG. 1 schematically shows a general configuration of a projector according to an embodiment of the invention.

FIG. 2 is an exploded perspective view schematically showing the configuration of an optical apparatus in the embodiment.

FIG. 3 is a schematic view showing the optical paths along which light fluxes travel in an emitting-side polarizing element in the embodiment.

FIG. 4 is a schematic view showing the optical path along which second linearly polarized light travels in a first prism in the embodiment.

FIG. 5 is a schematic view showing the optical path along which the second linearly polarized light reflected off a polarizing element body travels and impinges on a light flux incident-side end surface in the embodiment.

### DESCRIPTION OF EXEMPLARY EMBODIMENTS

An embodiment of the invention will be described below with reference to the drawings.

### Key Configuration of Projector

### Main Configuration of Projector

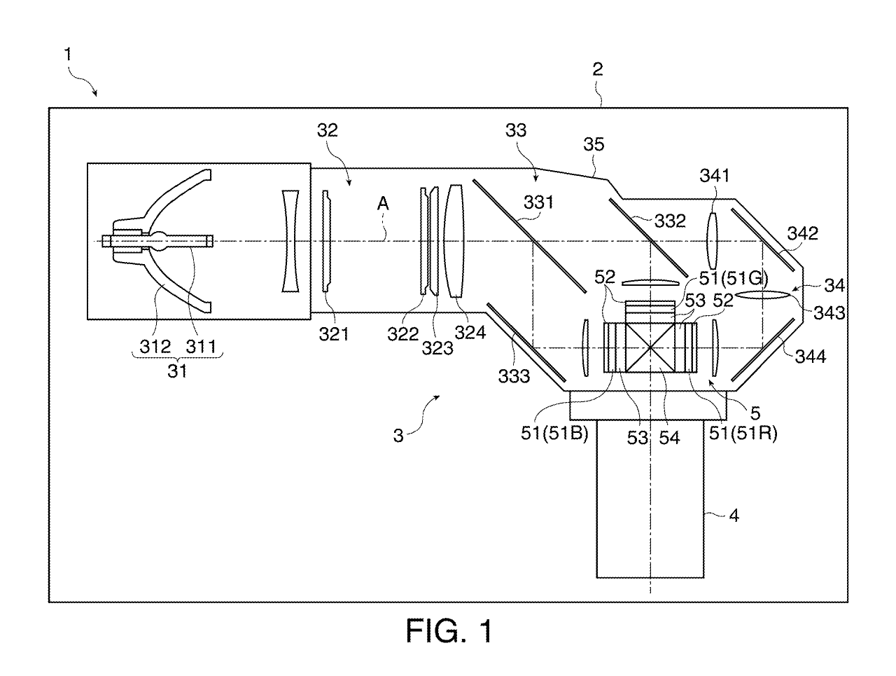

FIG. 1 schematically shows a general configuration of a projector 1.

The projector 1 modulates the light flux emitted from a light source in accordance with image information to form image light, and enlarges and projects the image light that has been formed on a screen (not shown). The projector 1 generally includes an optical unit 3, a projection lens 4 as the projection optical apparatus, and an outer housing 2 that houses the optical unit 3 and the projection lens 4 and forms the exterior, as shown in FIG. 1.

Although not specifically shown, the space in the outer housing 2 other than the space for the optical unit 3 and the projection lens 4 houses, for example, a cooling unit including a cooling fan that cools the interior of the projector 1, a power supply that supplies electric power to the components in the projector 1, and a control unit that controls the operation of the components in the projector 1.

The optical unit 3 forms image light according to image information by optically processing the light flux emitted from a light source apparatus 31 under the control of the control unit described above. The optical unit 3 includes the light source apparatus 31, an illumination optical apparatus 32, a color separation optical apparatus 33, a relay optical apparatus 34, an optical apparatus 5, and optical components housing 35 that houses the optical parts 31 to 34 and the optical apparatus 5 in predetermined positions with respect to an illumination optical axis A set in the optical part housing 35.

The light source apparatus 31 includes a light source lamp 311 and a reflector 312, as shown in FIG. 1. In the light source apparatus 31, the reflector 312 aligns the light fluxes emitted from the light source lamp 311 in a fixed light-emitting direction, and the aligned light fluxes are directed toward the illumination optical apparatus 32.

The illumination optical apparatus 32 includes a first lens array 321, a second lens array 322, a polarization conversion element 323, and a superimposing lens 324, as shown in FIG. 1. The first lens array 321 divides the light flux outputted from the light source apparatus 31 into a plurality of segmented light fluxes and focuses the divided light fluxes in the vicinity of the second lens array 322. Each of the segmented light fluxes outputted from the second lens array 322 is incident on the polarization conversion element 323 in such a way that the central axis (principal ray) of the segmented light flux is oriented perpendicular to the plane of incidence of the polarization conversion element 323, where the segmented light fluxes are converted into substantially one type of linearly polarized light fluxes and outputted. The plurality of segmented light fluxes having emitted from the polarization conversion element 323 as linearly polarized light fluxes and passed through the superimposing lens 324 are superimposed on each of three liquid crystal panels 51, which will be described later, in the optical apparatus 5.

The color separation optical apparatus 33 includes two dichroic mirrors 331, 332 and a reflection mirror 333, as shown in FIG. 1, which serve to separate the plurality of segmented light fluxes outputted from the illumination optical apparatus 32 into red (R), green (G), and blue (B) three color light fluxes.

The relay optical apparatus 34 includes a light incident-side lens 341, a relay lens 343, and reflection mirrors 342, 344, as shown in FIG. 1, and serves to guide the color light fluxes separated by the color separation optical apparatus 33, for example, guide the red light to a liquid crystal panel for red light 51R, which will be described later, in the optical apparatus 5.

The optical apparatus 5 modulates incident light fluxes in accordance with image information to form image light. The specific configuration of the optical apparatus 5 will be described later.

The projection lens 4 is a combination lens obtained by combining a plurality of lenses, and enlarges and projects the image light outputted from the optical apparatus 5 on the screen.

### Configuration of Optical Apparatus

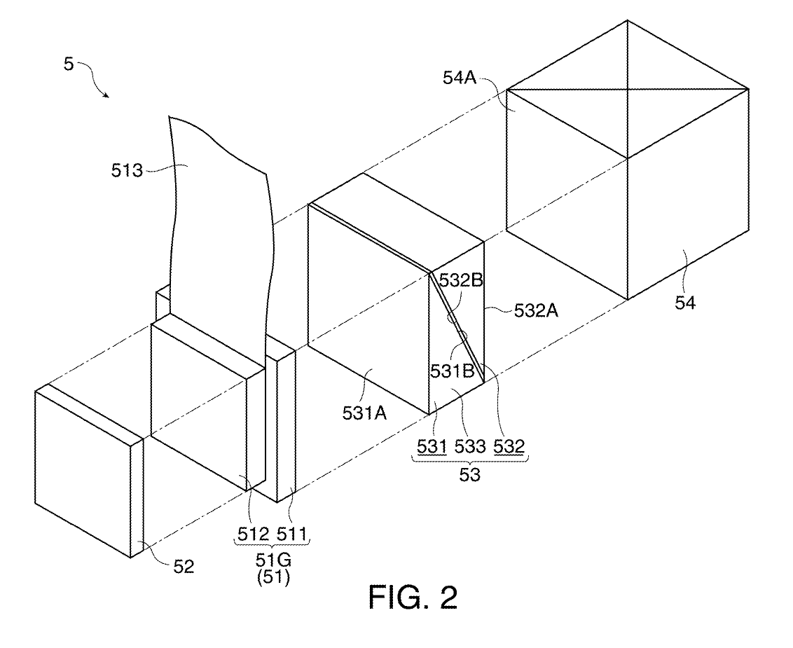

FIG. 2 is an exploded perspective view schematically showing the configuration of the optical apparatus 5.

FIG. 2 shows only the G light portion in the optical apparatus 5. The R and B light portions are configured in the same manner as the G light portion is.

The optical apparatus 5 includes the liquid crystal panels 51 (a liquid crystal panel for red light 51R, a liquid crystal panel for green light 51G, and a liquid crystal panel for blue light 51B) as the light modulators (optical elements), an incident-side polarizing element 52 disposed upstream of each of the liquid crystal panels 51 in the optical path, an emitting-side polarizing element 53 disposed downstream of each of the liquid crystal panels 51 in the optical path, and a cross dichroic prism 54 as a color combining optical apparatus, as shown in FIG. 1 or 2.

The configuration of each of the optical parts 51 to 54 will be described below sequentially from the one on the light flux incident side.

The incident-side polarizing element 52 transmits only linearly polarized light having a polarization direction that is substantially the same as the polarization direction aligned by the polarization conversion element 323. In the present embodiment, the incident-side polarizing element 52 is comprised of a reflective polarizer, as in the case of a polarizing element body 533, which will be described later.

The liquid crystal panel 51 encapsulates and seals liquid crystal molecules, an electro-optic substance, between a pair of substrates 511 and 512 made of glass or any other suitable material and having a rectangular shape when viewed from above, as shown in FIG. 2. The substrate 511, which is a drive substrate for driving the liquid crystal molecules, includes a plurality of data lines formed in an arrangement in which they are parallel to each other, a plurality of scan lines formed in an arrangement in which they are perpendicular to the plurality of data lines, pixel electrodes formed in a matrix arrangement at the intersections of the scan lines and the data lines, switching devices, such as TFTs (Thin Film Transistors), and a drive unit for driving the switching devices. The substrate 512, which is a counter substrate facing the substrate 511 and apart therefrom by a predetermined distance, includes a common electrode to which a predetermined voltage Vcom is applied. The substrates 511 and 512 are connected to an FPC cable 513 that serves as a circuit board electrically connected to the control unit and outputting predetermined drive signals to the scan lines, the data lines, the switching devices, the common electrode, and other components. When the control unit inputs the drive signals through the FPC cable 513, a voltage is applied between a predetermined one of the pixel electrodes and the common electrode, and the orientation of the liquid crystal molecules present between the pixel electrode and the common electrode is controlled. The polarization direction of the polarized light flux having emitted from the incident-side polarizing element 52 is thus modulated.

The emitting-side polarizing element 53 does not transmit all the light flux having emitted from the liquid crystal panel 51 but transmits only first linearly polarized light polarized perpendicular to the transmission axis of the incident-side polarizing element 52. The emitting-side polarizing element 53 includes a first prism 531, a second prism 532, and a polarizing element body 533, as shown in FIG. 2.

The first prism 531, which is comprised of a triangular prism having a substantially right-angled triangular cross-sectional shape, has a light flux incident-side end surface 531A on which the light flux having emitted from the liquid crystal panel 51 is incident and an emitting-side inclined surface 531B corresponding to the oblique side of the substantially right-angled triangular cross-sectional shape and inclined to the light flux incident-side end surface 531A.

The second prism 532 is comprised of a triangular prism the cross-sectional shape of which is the same as the right-angled triangular cross-sectional shape of the first prism 531. The second prism 532 has a light flux emitting-side end surface 532A parallel to the light flux incident-side end surface 531A of the first prism 531 and transmitting the first linearly polarized light, and an incident-side inclined surface 532B corresponding to the oblique side of the right-angled triangular cross-sectional shape and facing the emitting-side inclined surface 531B of the first prism 531. The refractive index of the second prism 532 is the same as that of the first prism 531.

The polarizing element body 533 is interposed between the emitting-side inclined surface 531B and the incident-side inclined surface 532B, and comprised of a reflective polarizer that transmits the first linearly polarized light and reflects second linearly polarized light. In the present embodiment, the polarizing element body 533 has a large number of fine, linear ribs made of aluminum or any other suitable material and parallel to one another on the surface facing the incident-side inclined surface 532B, although the ribs are not specifically illustrated. The polarizing element body 533 transmits linearly polarized light polarized perpendicular to the direction in which the linear ribs extend (first linearly polarized light) and reflects linearly polarized light polarized parallel to the direction in which the linear ribs extend (second linearly polarized light).

The emitting-side polarizing element 53 has a substantially box-like shape when the members 531 to 533 are in contact with each other and hence integrated, as shown in FIG. 2.

In FIG. 2, the emitting-side inclined surface 531B is inclined so that the second linearly polarized light is reflected off the polarizing element body 533 downward in the figure. The emitting-side inclined surface 531B may alternatively be inclined in any direction, upward, downward, rightward, or leftward, as long as the reflected light is not directed toward the liquid crystal panel 51.

The optical paths along which the light fluxes travel in the emitting-side polarizing element 53 (the first linearly polarized light and the second linearly polarized light) will be described later.

The cross dichroic prism 54 combines the color light fluxes having passed through the emitting-side polarizing elements 53 to form image light (color image). The cross dichroic prism 54 is formed by bonding four right-angled prisms and thus has a substantially square shape when viewed from above. Two dielectric multilayer films are formed along the interfaces between these bonded right-angled prisms. The dielectric multilayer films transmit the G light having emitted from the liquid crystal panel 51G and passed through the corresponding emitting-side polarizing element 53, whereas reflecting the R and B light having emitted from the liquid crystal panels 51R and 51B and passed through the corresponding emitting-side polarizing elements 53. The color light fluxes are thus combined to form a color image.

The members 51 to 54 described above are then integrated in the following manner:

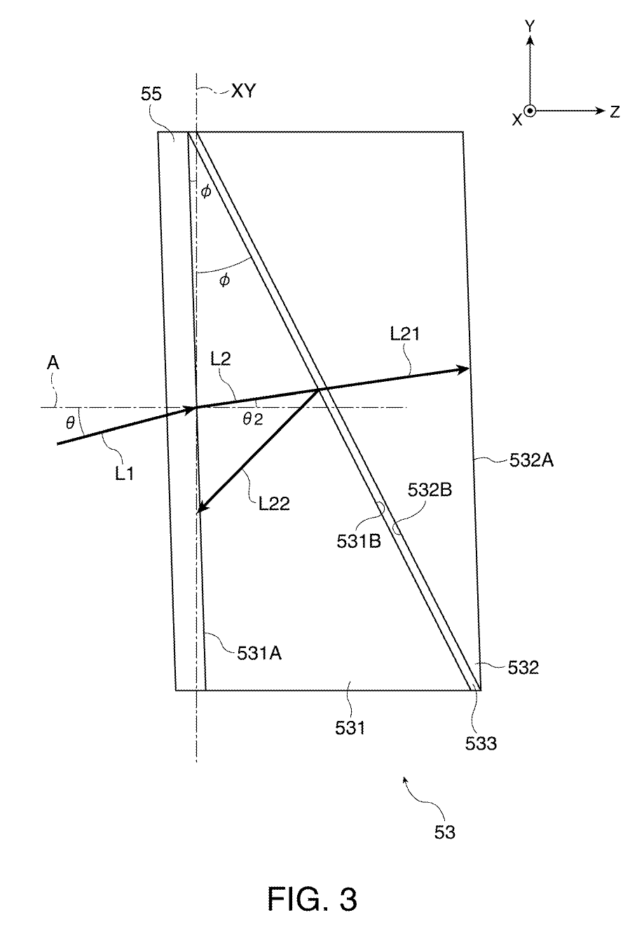

The light flux emitting-side end surface 532A of the emitting-side polarizing element 53 is bonded to a light flux incident-side end surface 54A of the cross dichroic prism 54 with an adhesive, and the light flux incident-side end surface 531A of the emitting-side polarizing element 53 is bonded to the drive substrate 511 for driving the liquid crystal panel 51 with an adhesive 55 (see FIG. 3), which will be described later. Further, the incident-side polarizing element 52 is fixed to the counter substrate 512, for example, with an adhesive.

Optical Paths Along which Light Fluxes Travel in Emitting-Side Polarizing Element

FIG. 3 is a schematic view showing the optical paths along which the light fluxes travel in the emitting-side polarizing element 53. Specifically, FIG. 3 is a longitudinal cross-sectional view of the emitting-side polarizing element 53.

In FIG. 3, X, Y and Z axes are defined as follows: The Z axis is the optical axis of the light flux emitted from the light source (illumination optical axis A) (Let the +Z axis direction be the direction in which the light flux is directed). The X axis is perpendicular to not only the Z axis but also a normal (not shown) to the light flux incident-side end surface 531A. The Y axis is perpendicular to the Z and X axes. Further, let the +Y axis direction be the direction in which the distance in the Z-axis direction between the light flux incident-side end surface 531A and the emitting-side inclined surface 531B decreases as the coordinate along the +Y axis increases (the upward direction in FIG. 3).

A light flux L1 having emitted from the liquid crystal panel 51 (see FIG. 2) passes through the epoxy-based adhesive 55 and impinges on the light flux incident-side end surface 531A, as shown in FIG. 3. The refractive index n0 of the adhesive 55 as an adhesive layer is set to satisfy the following equation (1),

1≦n1/n0×sin [2φ−arcsin {n0/n1×sin(θ−φ)}−2φ] (1)

where n1 represents the refractive index of the first prism 531; θ represents the angle between the illumination optical axis A and the light flux L1; φ represents the angle between the orthogonal plane XY and the light flux incident-side end surface 531A; and φ represents the angle between the orthogonal plane XY and the emitting-side inclined surface 531B. The angles θ, φ, and φ have positive values along the direction in which the +Z-axis is rotated around the X-axis toward the +Y-axis (counterclockwise direction in FIG. 3). The same argument applies to the angles described in the following sections.

For example, when the first prism 531 is made of a typical optical glass material BK7, the refractive index n1 of BK7 is 1.518. When θ=15 (°), φ=40 ( ), and φ=0 (°), the refractive index n0 of the adhesive 55 determined by the equation (1) satisfies n0≦1.43.

That is, SiO₂ having a refractive index of 1.40, MgF₂ having a refractive index of 1.39, or CaF₂ having a refractive index of 1.30 can be used as the adhesive 55 in this example.

The optical paths along which the light fluxes travel in the emitting-side polarizing element 53 and the derivation of the equation (1) will be described below.

First, the angle θ2 between the illumination optical axis A and a light flux L2 having passed through the light flux incident-side end surface 531A is determined by the following equation (2) based on Snell's law:

sin(θ−φ)/sin(θ2−φ)=n1/n0 (2)

The light flux L2 traveling through the first prism 531 is separated into first linearly polarized light L21 and second linearly polarized light L22 at the polarizing element body 533.

The first linearly polarized light L21 passes through the polarizing element body 533, passes through the second prism 532, emits through the light flux emitting-side end surface 532A, and enters the cross dichroic prism 54 (see FIG. 2). The adhesive (not shown) that bonds the light flux emitting-side end surface 532A to the light flux incident-side end surface 54A of the cross dichroic prism 54 has the same refractive index n0 as that of the adhesive 55. The first linearly polarized light L21 having emitted through the light flux emitting-side end surface 532A therefore travels in substantially the same direction as the direction in which the light flux L1 travels.

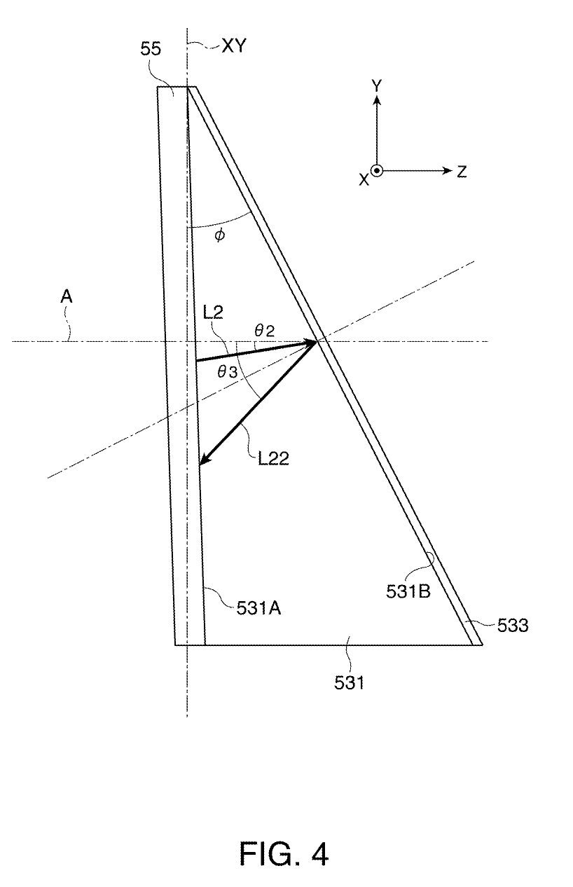

FIG. 4 is a schematic view showing the optical path along which the second linearly polarized light L22 travels in the first prism 531. In FIG. 4, the second prism 532 is not illustrated.

The second linearly polarized light L22 is reflected off the polarizing element body 533 toward the light flux incident-side end surface 531A, as shown in FIG. 4.

The angle θ3 between the illumination optical axis A and the second linearly polarized light L22 reflected off the polarizing element body 533 toward the light flux incident-side end surface 531A is determined by the following equation (3):

θ3=2φ−θ2 (3)

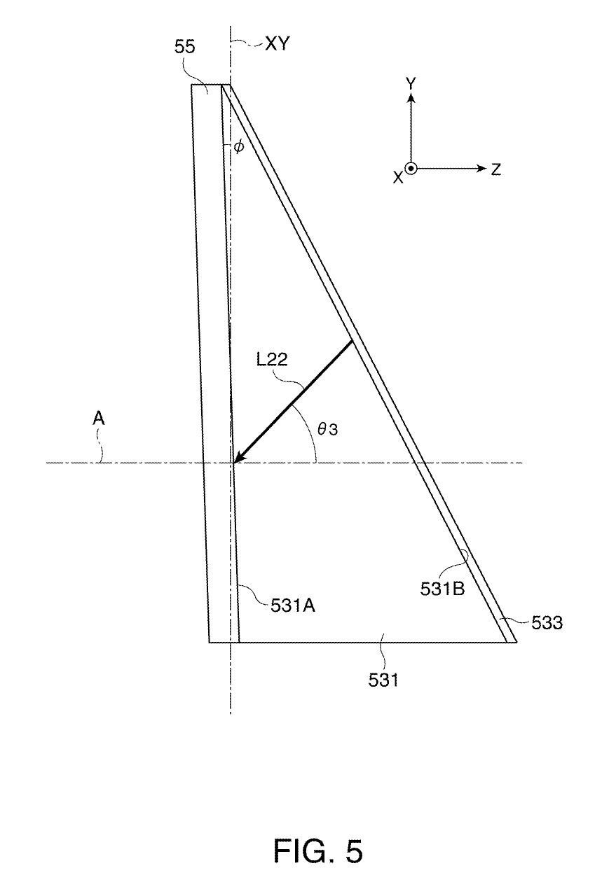

FIG. 5 is a schematic view showing the optical path along which the second linearly polarized light L22 reflected off the polarizing element body 533 travels and impinges on the light flux incident-side end surface 531A. In FIG. 5, the second prism 532 is not illustrated.

The second linearly polarized light L22 reflected off the polarizing element body 533 is incident on the light flux incident-side end surface 531A, as shown in FIG. 5.

Since the angle between the illumination optical axis A and the second linearly polarized light L22 is the angle θ3 determined by the equation (3), the second linearly polarized light L22 will be totally reflected off the light flux incident-side end surface 531A under the condition determined by the following equation (4) based on Snell's law:

1/sin(θ3−φ)≦n1/n0 (4)

The equation (1) described above can be derived by deleting the angles θ2 and θ3 from the equations (2) to (4) and organizing the resultant equation.

As described above, since the refractive index n0 of the adhesive 55 is set to satisfy the equation (1), the second linearly polarized light L22 reflected off the polarizing element body 533 is totally reflected off the light flux incident-side end surface 531A and is not directed toward the liquid crystal panel 51.

The present embodiment described above provides the following advantages:

(1) Integrating the liquid crystal panel 51 with the emitting-side polarizing element 53 with the adhesive 55 therebetween allows improvement in handleability and reduction in size.

(2) Since the refractive index n0 of the adhesive 55 is set to satisfy the equation (1), the second linearly polarized light L22 reflected off the polarizing element body 533 is totally reflected off the light flux incident-side end surface 531A and is not directed toward the liquid crystal panel 51. The light flux having emitted from the emitting-side polarizing element 53 will therefore not affect the liquid crystal panel 51.

(3) Since the liquid crystal panel 51 is bonded to the emitting-side polarizing element 53 with the adhesive 55 therebetween so that the space between the two members is sealed, no dust will adhere to the liquid crystal panel 51 or the emitting-side polarizing element 53. It is therefore not necessary to attach a dust protective glass on the light flux emitting side of the liquid crystal panel, the dust protective glass shifting any dust that has adhered from the focal position to prevent the dust from creating a shadow in the image light. The configuration of the optical apparatus 5 can therefore be simplified and further reduced in size.

(4) Since the emitting-side polarizing element 53 includes the second prism 532 having the light flux emitting-side end surface 532A parallel to the light flux incident-side end surface 531A of the first prism 531, the first linearly polarized light L21 that emits through the light flux emitting-side end surface 532A can be set to travel in substantially the same direction as that in which the light flux L1 incident on the emitting-side polarizing element 53 travels. Therefore, the incident-side polarizing element 52 disposed upstream of the liquid crystal panel 51 in the optical path and the cross dichroic prism 54 disposed downstream of the emitting-side polarizing element 53 in the optical path can also be incorporated in the optical apparatus 5, whereby the handleability can be further improved.

### Variations

The invention is not limited to the embodiment described above, but variations and modifications thereof are encompassed in the invention to the extent that they can achieve the advantage of some aspects of the invention.

While in the above embodiment, the epoxy-based adhesive 55 is used as the adhesive layer, the adhesive layer is not limited thereto. For example, a layer made of any of a fluorine-based coating agent, a silicon resin coating agent, and a metal oxide, such as SiO₂ or MgF₂, may be formed on the light flux incident-side end surface of the polarizing element, and the optical element and the polarizing element are bonded to each other, for example, by pressing them against each other. In essence, the optical element and the polarizing element only needs to be integrated with each other with the interposed adhesive layer formed on the light flux incident-side end surface.

While in the above embodiment, the optical parts 51 to 54 are integrated to form the optical apparatus 5, the configuration of the optical apparatus 5 is not limited thereto. At least the liquid crystal panel 51 should be integrated with the emitting-side polarizing element 53, but the other optical parts 52 and 54 may not be integrated.

While the above embodiment has been described with reference to the emitting-side polarizing element 53 as the polarizing element, the incident-side polarizing element 52 may also be configured in the same manner as the emitting-side polarizing element 53 is, and the optical element disposed upstream of the incident-side polarizing element 52 in the optical path may be integrated therewith.

While in the above embodiment, the liquid crystal panel 51 is used as the optical element, the optical element is not limited thereto. The optical element may alternatively be a retardation film, a viewing angle compensator (a WV film (manufactured by FUJIFILM Corporation) or any other suitable optical compensation film attached to a light-transmissive substrate), a light-transmissive substrate made of quartz, sapphire, or any other suitable material having a relatively high thermal conductivity, or other optical elements.

While in the above embodiment, the emitting-side polarizing element 53 includes not only the first prism 531 and the polarizing element body 533 but also the second prism 532, the configuration of the emitting-side polarizing element 53 is not limited thereto. The emitting-side polarizing element 53 may be configured without the second prism 532.

While in the above embodiment, the first prism 531 and the second prism 532 have substantially the same shape and the same refractive index, the first prism 531 and the second prism 532 are not necessarily configured as described above, but may alternatively differ from each other in terms of shape and refractive index.

In the above embodiment, the polarizing element body 533 is not necessarily configured as described above, but may be configured in any manner as long as it serves as a reflective polarizer.

For example, the polarizing element body 533 may be a polarization separation element formed of a dielectric multilayer film; a polymer-based laminar polarizing plate obtained by stacking organic material layers, each of which having refractive index anisotropy (birefringence), such as liquid crystal materials; an optical element obtained by combining a circularly polarized light reflector that separates unpolarized light into right-handed circularly polarized light and left-handed circularly polarized light with a quarter wave plate; a Brewster angle optical element that separates light into reflected polarized light and transmitted polarized light; or a hologram optical element using a hologram.

While the above embodiment has been described only with reference to a front-projection projector, the invention is also applicable to a rear-type projector that includes a screen and projects an image from the backside of the screen.

The invention, which allows improvement in handleability and reduction in size, is applicable to a projector used for presentation and in a home theater.

The entire disclosure of Japanese Patent Application No. 2008-071997, filed Mar. 19, 2008 and the entire disclosure of Japanese Patent Application No. 2009-008650, filed Jan. 19, 2009 are expressly incorporated by reference herein.

What is claimed is:

1. An optical apparatus comprising:
an optical element disposed on an optical path along which the light flux emitted from a light source travels;
a polarizing element disposed on the light flux emitting-side of the optical element, the polarizing element including:
a first prism having:
a light flux incident-side end surface on which the light flux having emitted from the optical element is incident; and
an emitting-side inclined surface inclined to the light flux incident-side end surface; and
a polarizing element body provided on the emitting-side inclined surface, the polarizing element body transmitting first linearly polarized light out of the light flux having passed through the first prism and reflecting second linearly polarized light polarized perpendicular to the first linearly polarized light toward the first prism; and an interposed adhesive layer formed on the light flux incident-side end surface, the optical element being integrated with the polarizing element with the interposed adhesive layer, and the refractive index n0 of the adhesive layer setting to satisfy the following equation:
1≦n1/n0×sin [2φ−arcsin {n0/n1×sin(θ−φ)}−2φ]
where n1 represents the refractive index of the first prism, θ represents the angle between the optical axis of the light flux emitted from the light source and the light flux incident on the light flux incident-side end surface, φ represents the angle between a plane orthogonal to the optical axis and the light flux incident-side end surface, and φ represents the angle between the orthogonal plane and the emitting-side inclined surface.

2. The optical apparatus according to claim 1,
wherein the polarizing element further includes a second prism having a light flux emitting-side end surface parallel to the light flux incident-side end surface and transmitting the first linearly polarized light having passed through the polarizing element body, and an incident-side inclined surface inclined to the light flux emitting-side end surface and facing the emitting-side inclined surface, and
the second prism is integrated with the first prism.

3. The optical apparatus according to claim 1,
wherein the optical element is comprised of a light modulator including a drive substrate and a counter substrate facing each other and liquid crystal molecules encapsulated between the drive substrate and the counter substrate, the light modulator modulating the incident light flux in accordance with image information to form image light.

4. A projector comprising:
a light source apparatus;
a light modulator that modulates the light flux emitted from the light source apparatus in accordance with image information to form image light;
a projection optical apparatus that enlarges and projects the image light; and
the optical apparatus according to claim 1.
